(19) United States
(12) Patent Application Publication
(10) Pub. No.: US 2026/0290689 A1
(43) Pub. Date: Sep. 24, 2026

(54) MULTILAYER ELECTRICAL COMPONENT

(71) Applicant: Knowles (UK) Limited, Norwich (GB)

(72) Inventors: George W. Kerridge, Norwich (GB); Steve Hopwood, Norwich (GB); Yacht Feng, Suzhou (CN)

(21) Appl. No.: 19/557,466

(22) Filed: Mar. 5, 2026

Related U.S. Application Data
(60) Provisional application No. 63/775,568, filed on Mar. 21, 2025.

(51) Int. Cl. H01G 4/005; H01G 4/12; H01G 4/232; H01G 4/30

(52) U.S. Cl. CPC H01G 4/005; H01G 4/12; H01G 4/232; H01G 4/30

(57) ABSTRACT

A plurality of parallel plate internal electrodes forms a stack of electrode layers embedded in the dielectric body. First and second groups of internal electrodes of the plurality of parallel plate internal electrodes. Each group includes a first internal electrode and a nearby second internal electrode. A first gap of the first internal electrode is offset relative to a second gap of the second internal electrode. A section of the first internal electrode overlaps with a section of the second internal electrode to form a region of capacitance in each group of internal electrodes. A set of at least two third internal electrodes of the plurality of parallel plate internal electrodes are located between the first and second groups of internal electrodes. The third internal electrodes are stacked adjacent to each other and form a region of negligible capacitance.

### BENEFIT CLAIM

This application claims the benefit of provisional application 63/775,568, filed Mar. 21, 2025, the entire contents of which is hereby incorporated by reference.

### FIELD

The present disclosure relates generally to multilayer electrical components, like capacitors and varistors, having improved robustness and performance.

### BACKGROUND

Multilayer ceramic capacitors (MLCCs) generally comprise multiple parallel plate electrodes, also referred to herein as “electrodes”, embedded in a ceramic dielectric body. Portions of the dielectric body separate adjacent electrodes connected to opposite polarity conductive terminations capping end portions of the dielectric body. MLCC capacitors can be surface mounted on a printed circuit board using reflow soldering or other surface mounting technology for use in various applications, including high voltage and high-frequency applications, among others.

Prior art FIG. 1 illustrates an MLCC 100 comprising multiple parallel plate electrodes embedded in a dielectric body 102 capped by conductive terminations 104, 106. Each electrode comprises multiple electrically isolated plate portions 108, 110 located in a common plane. An endmost plate of odd number electrodes is connected to the termination 104, and an endmost plate of even numbered electrodes is connected to the other termination 106. Overlapping plate portions of adjacent electrodes form a series arrangement of capacitors (e.g., C1, C3 and C5) between the terminations in parallel with another series arrangement of capacitors (e.g., C2, C4 and C6) between the terminations. Each series capacitor drops a portion of the voltage applied across the conductive terminations.

These and other MLCCs are susceptible to stress fractures due to piezoelectric or electrostrictive forces along common boundaries between adjacent series capacitors (e.g., boundaries between capacitors C1, C3 and C5 aligned with boundaries between capacitors C2, C4 and C6), the boundaries being associated with gaps 111 separating the plate portions in a common plane. The occurrence of stress fractures is aggravated in applications where the MLCC is subject to higher voltages and higher frequencies.

For example, alternating electrodes generate regions of overlap that generate capacitance, such as the capacitors C1-C6. These capacitance regions generate strain, especially when high-voltage impulses are applied to the MLCC 100. The strain can cause piezoelectric cracking.

To elaborate, there is a problem that during situations where a ceramic capacitor experiences a sudden applied voltage, a common failure mode is due to the piezoelectric nature of the ceramic. The sudden dimensional change due to the piezoelectric effect causes high internal strain build up, causing cracking to occur at or near the middle of the MLCC. An impulse test for safety capacitors is one such test where a sudden voltage pulse is applied. The density of capacitance in an MLCC increases the risk of piezoelectric cracking and this issue limits the maximum capacitance that passes the testing.

Extra thick dielectric layers can be inserted between sets of electrodes to provide vertical gaps that prevent local buildup of the strain. Unfortunately, these vertical gaps do not optimally prevent the buildup of the strain. Also, these vertical gaps need to be many times thicker than the usual dielectric layers to be effective, which takes up extra space. Thus, there is a desire to provide multilayer capacitors having improved robustness and performance.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only example embodiments of the disclosure and are not therefore to be considered to be limiting of its scope. The drawings may have been simplified for clarity and are not necessarily drawn to scale.

FIG. 1 is a schematic sectional view of a prior art multilayer ceramic capacitor.

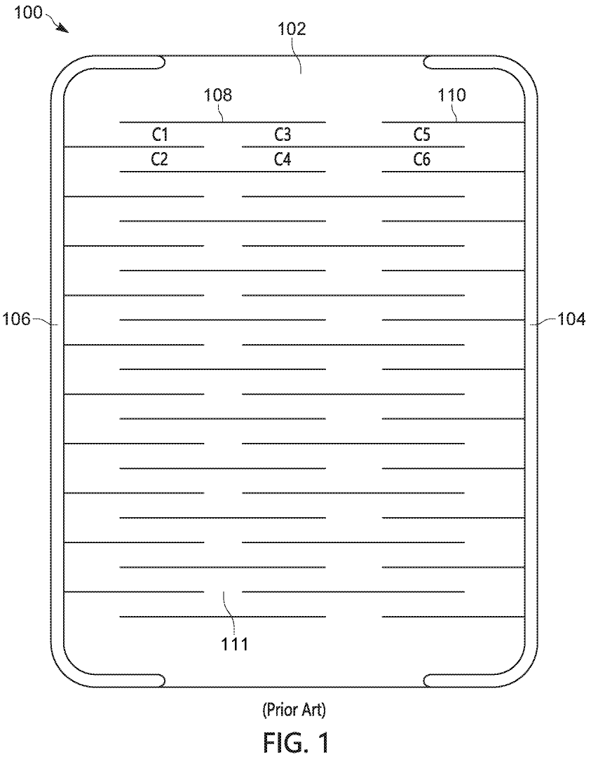

FIG. 2 is a sectional view of a multilayer electrical component including multiple capacitive layers according to a possible embodiment.

FIG. 3 is a schematic sectional view of a multilayer electrical component including multiple capacitive layers according to a possible embodiment.

FIG. 4 is a sectional view of a multilayer electrical component including multiple capacitive layers according to a possible embodiment.

FIG. 5 is a schematic sectional view of a multilayer electrical component including multiple capacitive layers according to a possible embodiment.

FIG. 6 is a schematic sectional view of a multilayer electrical component including multiple capacitive layers according to a possible embodiment.

### DETAILED DESCRIPTION

The disclosure relates generally to multilayer electrical components, like capacitors and varistors among other components, having improved robustness and performance. The multilayer electrical component generally comprises a dielectric body separating conductive terminations coupled to multiple parallel plate electrodes embedded in the dielectric body. Representative implementations are described further herein.

The composition of the dielectric material is typically selected based on operating temperature range, temperature stability, energy density, loss factor and relative permittivity, among other requirements or specifications of the multilayer electrical component. Suitable dielectric materials include ceramics and porcelains among other known and future materials. A representative ceramic comprises barium titanate and additives like glass and rare earth materials. Another representative ceramic comprises bismuth ferrite, strontium titanate and additives like barium titanate among other elements and compounds. Other representative ceramics can comprise magnesium titanate, neodymium titanate, strontium titanate, or calcium zirconate, among other compounds. Ceramics are currently favored for their ability to be formed by sintering a compositional powder during the manufacture of the electrical component.

The electrodes can be formed of a precious or base metal. The conductive terminations can be implemented as caps formed on opposite sides or end portions of the dielectric body. The terminations can also comprise a base or precious metal. Representative examples include electroplated silver, copper, and palladium/silver, among other metals and alloys. The terminations can also comprise metals and non-metal materials compositions. The multilayer electrical component (e.g., capacitor, varistor…) can be configured for surface mounting with or without leads for through-hole mounting or for some other known or future mounting technology.

### Overview

At least some embodiments provide paired electrode distribution for piezoelectric crack resistance. Electrodes are paired in a stacking direction of an MLCC. The paired electrodes are two electrodes that have the same polarity, which results in no substantial piezoelectric effect occurring within the ceramic. In an implementation, paired electrodes are distributed at regular intervals into a regular internal electrode pattern stack.

Electrode pairs that form regions of negligible capacitance can be located anywhere in between electrode pairs that form regions of capacitance in the dielectric body. Other paired electrodes can also be used at the top and bottom of MLCC structures to prevent flashover. Vertical gaps, such as a wider spacing between vertically stacked electrodes in the structure, have a similar effect but are less effective and are less volumetrically efficient than the electrode pairs that form regions of negligible capacitance.

Embodiments relate to any MLCC that has a requirement for an impulse test performance and to other MLCCs. Testing indicates significant improvement in impulse performance over current standard designs, where paired electrode design showed anti-piezoelectric properties. Embodiments drive higher capacitances than allowed by current technology, such as for safety capacitors. Embodiments also improve reliability in applications where rapid transients are experienced.

According to a possible embodiment, an MLCC includes a dielectric body. The MLCC includes first and second conductive terminations separated by the dielectric body. The MLCC includes a plurality of parallel plate internal electrodes forming a stack of electrode layers embedded in the dielectric body. The MLCC includes first and second groups of internal electrodes of the plurality of parallel plate internal electrodes. Each group includes a first internal electrode and a separate nearby second internal electrode. A first gap of the first internal electrode is offset relative to a second gap of the second internal electrode in a first direction between the first and second conductive terminations. A section of the first internal electrode overlaps with a section of the second internal electrode to form a region of capacitance in each group of internal electrodes. The MLCC includes a set of at least two third internal electrodes of the plurality of parallel plate internal electrodes located between the first and second groups of internal electrodes. The at least two third internal electrodes are stacked adjacent to each other and form a region of negligible capacitance.

### Vertical Gaps

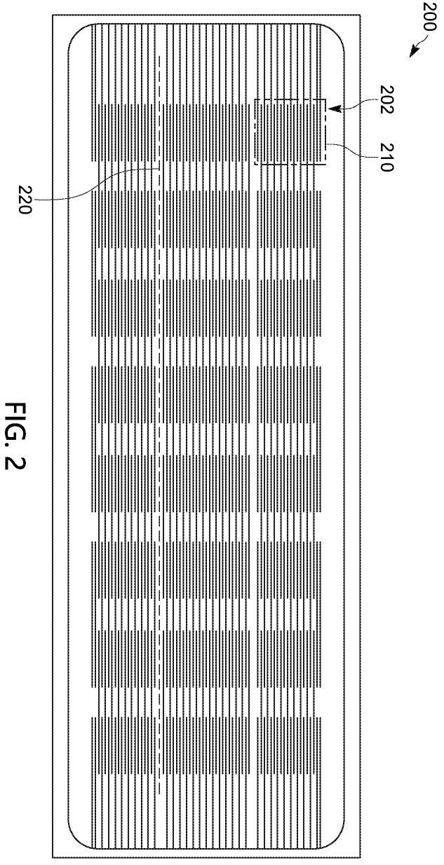

FIG. 2 is a sectional view of a multilayer electrical component 200, such as an MLCC, including multiple capacitive layers according to a possible embodiment. Alternating electrodes 202 have regions 210 of overlap that generate capacitance. The capacitance regions 210 generate strain, which can cause piezoelectric cracking. Vertical gaps, such as gap 220, in the electrode layers reduce the strain.

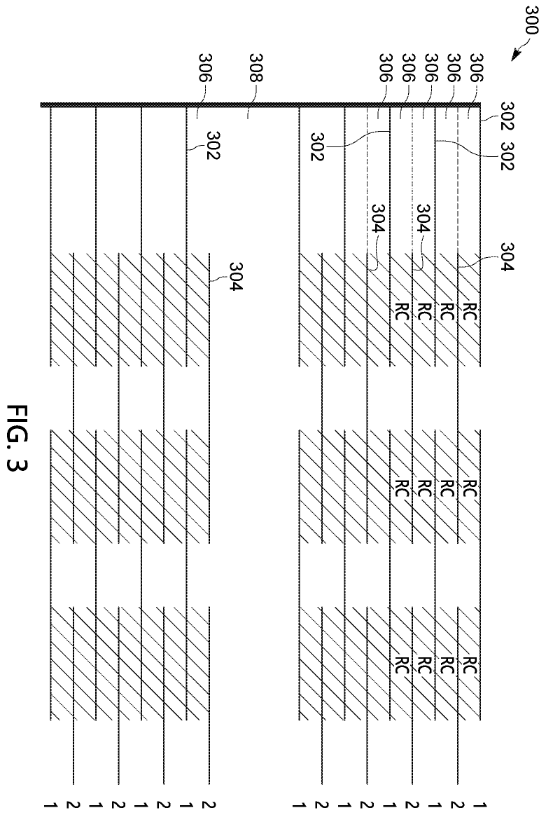

FIG. 3 is a schematic sectional view of a multilayer electrical component 300, such as the MLCC 200, including multiple capacitive layers according to a possible embodiment. The MLCC 300 includes sets of first and second internal electrodes 302 and 304, dielectric layers 306, and regions of capacitance RC. The first internal electrodes 302 can be internal electrodes of a first type 1, such as with a first voltage potential and/or polarity. The second internal electrodes 304 can be internal electrodes of a second type 2, such as with a second voltage potential and/or polarity. The dielectric layers 306 can be ceramic layers that are between the internal electrodes 302 and 304 in the vertical direction. Sections of the first internal electrodes 302 that overlap with sections of the second internal electrodes 304 form the regions of capacitance RC.

The regions of capacitance RC generate strain, especially when high-voltage impulses are applied to the MLCC 300. At least one extra thick dielectric layer 308, such as a vertical gap, between sets of first and second internal electrodes 302 and 304 prevents local buildup of the strain. Such vertical gaps do not optimally prevent buildup of the strain and need to be many times thicker than the usual dielectric layers to be effective, which takes up extra space.

### PAIRED ELECTRODE WITH MULTIPLE PLATE PORTIONS

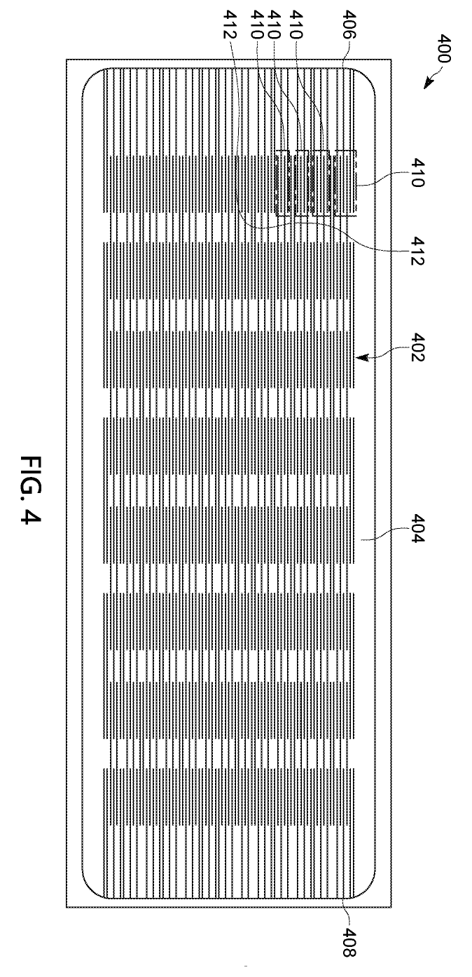

FIG. 4 is a sectional view of a multilayer electrical component 400, such as an MLCC, including multiple capacitive layers according to a possible embodiment. The MLCC 400 includes stacked internal electrodes 402, a dielectric body 404, and conductive terminations 406 and 408. Groups of internal electrodes 402 overlap and generate regions of capacitance 410.

The inclusion of paired internal electrodes 412 throughout the build makes the regions of capacitance 410 smaller in the stacked direction, preventing local strain build up, which otherwise encourages piezoelectric cracking failures. The paired internal electrodes 412 are located between the regions of capacitance 410. The paired internal electrodes 412, by design, do not generate capacitance.

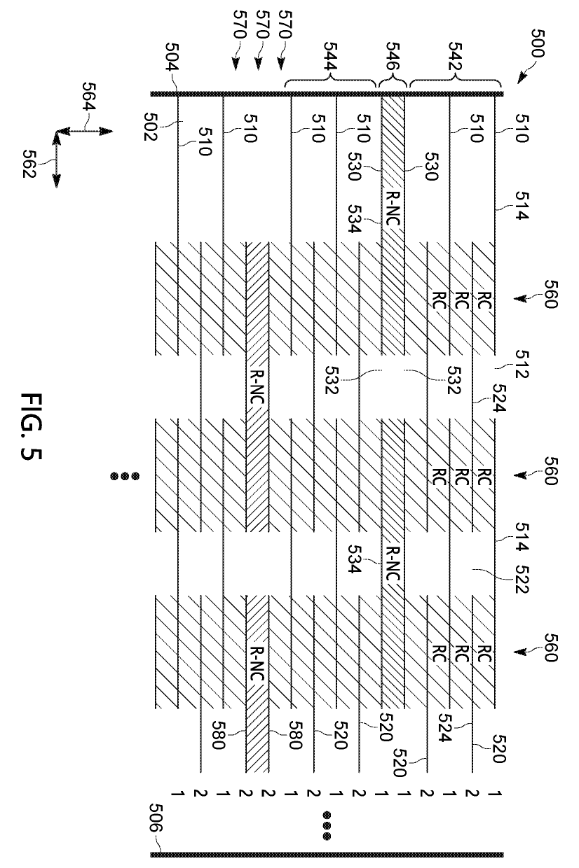

FIG. 5 is a schematic sectional view of a multilayer electrical component 500, such as the MLCC 400, including multiple capacitive layers according to a possible embodiment. The MLCC includes a dielectric body 502, conductive terminations 504 and 506, internal electrodes 510, 520, 530, and 580, regions of capacitance RC, and regions of negligible capacitance R-NC. Dielectric layers 570, such as ceramic layers, are located between adjacent electrodes. The conductive terminations 504 and 506 are external electrodes. The internal electrodes 510 and 530 can be internal electrodes of a first type 1, such as with a first voltage potential and/or polarity. The internal electrodes 520 and 580 can be internal electrodes of a second type 2, such as with a second voltage potential and/or polarity. At least one set of electrodes 530 and/or 580 are paired by repeating electrodes of the same type to create the areas of negligible capacitance R-NC.

According to a possible embodiment, the MLCC 500 includes a dielectric body 502. The MLCC 500 also includes first and second conductive terminations 504, 506 separated by the dielectric body 502. The MLCC 500 further includes a plurality of parallel plate internal electrodes 510, 520, 530 forming a stack of electrode layers embedded in the dielectric body 502. Each of the parallel plate internal electrodes includes plate portions 514, 524 that are electrically isolated from each other by at least one gap 512, 522.

The MLCC 500 includes first and second groups 542, 544 of internal electrodes of the plurality of parallel plate internal electrodes. A first gap 512 in a first internal electrode 510 is offset relative to a second gap 522 in a separate nearby second internal electrode 520 in each group 542, 544 in a first direction 562 between the first and second conductive terminations 504, 506. The plurality of parallel plate internal electrodes 510, 520, 530 form a stack of internal electrodes in a second direction 564 perpendicular to the first direction 562. The first and second directions can also be considered first and second dimensions. Sections of the plate portions of the first internal electrode 510 overlap 560 with sections of plate portions of the second internal electrode 520 to form regions of capacitance RC, in each group of internal electrodes 542, 544.

The MLCC 500 includes a set 546 of at least two third internal electrodes 530 of the plurality of parallel plate internal electrodes. The set 546 of at least two third internal electrodes 530 is located between the first and second groups of internal electrodes 542, 544. The at least two third internal electrodes 530 are stacked adjacent to each other and form regions of negligible capacitance R-NC.

There can be many gaps across each electrode layer. For example, there can be 2, 3, 5, 8, 16, or any other number of gaps in each electrode layer. There may also be many electrode layers.

According to a possible implementation, the first internal electrodes 510 have a different polarity than the second internal electrodes 520. The third internal electrodes 530 have the same polarity as each other. For example, the first internal electrodes 510 have a different voltage potential than the second internal electrodes 520, and the third internal electrodes 530 have the same voltage potential as each other. In an implementation, the third internal electrodes 530 have the same polarity and/or same voltage potential as the first internal electrodes 510.

According to a possible implementation, the third internal electrodes 530 in the set 546 each comprise a gap 532 that overlaps with a gap 532 of the other third internal electrode 530 to form overlapping plate sections 534 with the regions of negligible capacitance R-NC therebetween.

According to a possible implementation, first internal electrodes 510 alternate with immediately adjacent second internal electrodes 520 in the first and second groups of internal electrodes 542, 546. For example, individual first internal electrodes 510 can alternate with individual second internal electrodes 520 in the groups of internal electrodes.

In a possible embodiment, gaps 512 in at least one upper layer first internal electrode 510 are offset from gaps 512 in at least one lower layer first internal electrode 510 and gaps 532 in upper and lower second internal electrodes 520 are similarly offset to form staggered plate portions.

According to a possible implementation, interaction between the plate portions of first and second internal electrodes 510, 520 stacked in adjacent layers produces a piezoelectric effect having a corresponding internal strain in the MLCC 500. The stacked third internal electrodes 530 reduces the corresponding internal strain.

According to a possible implementation, each of the internal electrodes of the plurality of parallel plate internal electrodes is separated from each other by a dielectric layer 570.

According to a possible implementation, the first and second groups 542, 544 of internal electrodes are a plurality of first and second groups of internal electrodes. The set 546 of at least two third internal electrodes 546 is a plurality of sets of at least two third internal electrodes 546. Each set 546 of at least two third internal electrodes 530 located between respective first and second groups 542, 544 of internal electrodes.

The MLCC 500 can include other sets of paired internal electrodes, such as fourth internal electrodes 580. The paired fourth internal electrodes 580 are located between other groups of first and second internal electrodes 510 and 520 and form additional regions of negligible capacitance R-NC to reduce internal strain. The paired third internal electrodes 530 can be of the same type 1 as the first internal electrodes 510, and the paired fourth internal electrodes 580 can be of the same type 2 as the second internal electrodes 520.

### Paired Electrodes with Single Plate Portions

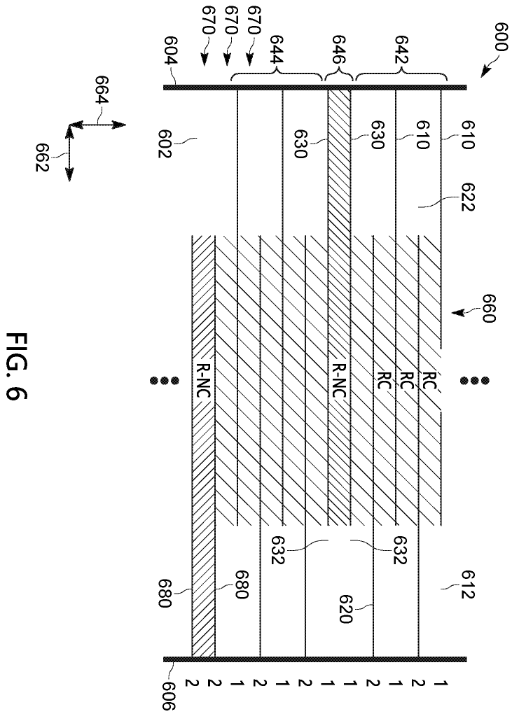

FIG. 6 is a schematic sectional view of a multilayer electrical component 600, such as an MLCC, including multiple capacitive layers according to a possible embodiment. The MLCC 600 incorporates the features of the MLCC 500, and the features of the MLCC 600 can also be used with the MLCC 500.

According to a possible embodiment, the MLCC 600 includes a dielectric body 602. The MLCC 600 also includes first and second conductive terminations 604, 606 separated by the dielectric body 602. The MLCC 600 further includes a plurality of parallel plate internal electrodes 610, 620, 630 that form a stack of electrode layers embedded in the dielectric body 602.

The MLCC 600 includes first and second groups 642, 644 of internal electrodes of the plurality of parallel plate internal electrodes. Each group 642, 644 includes a first internal electrode 610 and a separate nearby second internal electrode 620. Each first and second group 642, 644 can include a plurality of the first and second internal electrodes 610, 620.

A first gap 612 of the first internal electrode 610 is offset relative to a second gap 622 of the separate nearby second internal electrode in a first direction 662 between the first and second conductive terminations 604, 606. The gaps 612 and 614 can be between an internal electrode and at least one of the conductive terminations 604, 606 and/or can be a gap between plate portions of an internal electrode, as shown in the MLCC 500. A section of the first internal electrode 610 overlaps 660 with a section of the second internal electrode 620 to form regions of capacitance RC in each group of internal electrodes 642, 644.

The MLCC 600 includes a set 646 of at least two third internal electrodes 630 of the plurality of parallel plate internal electrodes located between the first and second groups 642, 644 of internal electrodes. The at least two third internal electrodes 630 are stacked adjacent to each other and form a region of negligible capacitance R-NC.

Capacitance is defined as substantial capacitance for the operation of a capacitor. Negligible capacitance is defined as capacitance that is minimal compared to the operating capacitance of a capacitor, such as any range between 5%, 1%, 0.1%, 0.01%, or less than the operating capacitance. For example, regions of negligible capacitance can be regions without substantial capacitance and/or regions of substantially no capacitance, which is effectively zero capacitance when compared to the operating capacitance, while taking into consideration that absolute zero capacitance may not be physically possible because minor stray capacitance may always exist.

Embodiments are shown where gaps and portions of electrodes of a particular type directly overlap with each other. Embodiments can also be used with staggered electrodes, where gaps and portions of electrodes of a particular type are offset relative to each other in the first direction 662. For example, the gaps and portions of an upper internal electrode of the first type 1 can be offset from gaps and portions of a lower internal electrode of the first type 1.

According to a possible implementation, the first internal electrodes 610 can be of a first type 1 that has a different voltage potential than the second internal electrodes 620 of a second type 2. The third internal electrodes 630 can have the same voltage potential as each other. The third internal electrodes 630 can be of the first type 1 or the second type 2. For example, the third internal electrodes 630 can have the same voltage potential as the first internal electrodes 610.

According to a possible implementation, the third internal electrodes 630 each can include a gap 632 that overlaps with a gap 632 of the other third internal electrode 630 in the first direction 662 to form overlapping plate sections with the regions of negligible capacitance R-NC therebetween. The gap 632 of the third internal electrodes 630 can overlap with the gap 612 of the first internal electrode 610. Alternatively, the gap of the third internal electrodes can overlap with the gap 622 of the second internal electrode 620 or additional electrodes 680 can be paired, where gaps of the additional electrodes 680 overlap with each other and with the gap 622 of the second internal electrode 620.

According to a possible implementation, interaction between the plate portions of first and second internal electrodes 610, 620 stacked in adjacent layers produces a piezoelectric effect having a corresponding internal strain in the MLCC 600. The stacked third internal electrodes 630 reduces the corresponding internal strain. For example, the piezoelectric effect can cause a buildup of internal strain within the MLCC 600 that causes the MLCC 600 to crack. The regions of negligible capacitance R-NC of the paired additional electrodes 680 also reduce the internal strain.

According to a possible implementation, the plurality of parallel plate internal electrodes 610, 620, 630 form a stack of internal electrodes in a second direction 664 perpendicular to the first direction 662. According to a possible implementation, each internal electrode of the plurality of parallel plate internal electrodes 610, 620, 630 is separated from each other by a dielectric layer 670. The dielectric layers between all electrodes are the same size, such as substantially the same size, in the second direction. According to a possible implementation, at least one of the parallel plate internal electrodes 610, 620, 630 includes plate portions that are electrically isolated from each other by at least one gap in the first direction, such as shown in the MLCC 500.

In various implementations, the MLCC 400 and the MLCC 500 are not limited to a particular number of groups or sets of internal electrodes or a particular number of internal electrodes in each group or set. For example, first and second groups of internal electrodes can include a plurality of first groups of internal electrodes and a plurality of second groups of internal electrodes. The set of at least two third internal electrodes can include a plurality of sets of at least two third internal electrodes. Each set of at least two third internal electrodes can be located between each respective first group of internal electrodes and each respective second group of internal electrodes. In another example, each group includes a plurality of first internal electrodes stacked with a plurality of second internal electrodes, where at least one first internal electrode alternates with at least one second internal electrode.

In another example, an MCLL includes a plurality of groups of internal electrodes. Each group of internal electrodes includes the first group of internal electrodes, the second group of internal electrodes, and at least one more group of internal electrodes. The at least one more group of internal electrodes can include at least one fourth internal electrode and a separate nearby at least one fifth internal electrode stacked with the fourth internal electrode in a second direction perpendicular to the first direction.

### Further Example Embodiments

According to a first additional example embodiment, a multilayer ceramic capacitor includes:

a dielectric body;

first and second conductive terminations, such as external electrodes, separated by the dielectric body;

parallel plate first internal electrodes embedded in the dielectric body, where at least one first gap in each first internal electrode forms first plate portions that are electrically isolated from each other;

parallel plate second internal electrodes embedded in the dielectric body, where at least one second gap in each second internal electrode forms second plate portions that are electrically isolated from each other;

the at least one second gap offset from the at least one first gap in a first longitudinal direction extending between the first and second conductive terminations, the second plate portions overlap with the at least one first gap and the first plate portions overlap with the at least one second gap;

a first group of electrodes including a first set of the first internal electrodes and a second set of the second internal electrodes,

each first internal electrode of the first set of the first internal electrodes separated from each second internal electrode of the second set of the second internal electrodes by a dielectric layer;

a second group of electrodes including a third set of the first internal electrodes and a fourth set of the second internal electrodes,

each first internal electrode of the third set of the first internal electrodes separated from each second internal electrode of the fourth set of the second internal electrodes by a dielectric layer; and

a fifth set, such as the set of third internal electrodes of the first internal electrodes, separated from each other by a dielectric layer,

the fifth set of first internal electrodes located between the first group of electrodes and the second group of electrodes.

In a possible implementation, in the first group and the second group, a particular first internal electrode is separated from a particular second internal electrode by a dielectric layer.

In an implementation of the multilayer ceramic capacitor of the first additional example embodiment, a first plate portion of the first internal electrodes overlaps with the at least one second gap and a second plate portion of the second internal electrodes overlaps with the at least one first gap in a latitudinal direction perpendicular to the first direction.

In an implementation of the multilayer ceramic capacitor of the first additional example embodiment, wherein sections of the first plate portions overlap with sections of the second plate portions in respective first and second groups of electrodes to form regions of capacitance. Sections of the first plate portions that overlap with other sections of the first plate portions in the fifth set form a region of negligible capacitance.

In an implementation of the multilayer ceramic capacitor of the first additional example embodiment, wherein the fifth set of first internal electrodes are located between the first group of electrodes and the second group of electrodes in a second direction perpendicular to the first direction, and wherein the fifth set of first internal electrodes are parallel with each other and are separated from each other in the second direction.

In an implementation of the multilayer ceramic capacitor of the first additional example embodiment, wherein at least one first plate portion comprises a floating electrode electrically isolated from other first plate portions by first gaps on each side of the floating electrode in the first direction.

In an implementation, the multilayer ceramic capacitor of the first additional example embodiment further comprises:

a third group of electrodes including first internal electrodes alternating with second internal electrodes;

a fourth group of electrodes including first internal electrodes alternating with second internal electrodes in parallel; and

a sixth set of the second internal electrodes separated from each other by a dielectric layer, the sixth set of the second internal electrodes located between the third group of electrodes and the fourth group of electrodes, the sixth set of the second internal electrodes forming regions of negligible capacitance.

The number of paired electrodes with negligible capacitance is not limited. For example, there can be repeating groups of electrodes with regions of capacitance and repeating sets of electrodes with regions of negligible capacitance in between. Various numbers of electrodes in the groups and sets are possible. Also, various patterns of groups and sets are also possible.

In an implementation of the multilayer ceramic capacitor of the first additional example embodiment, each first internal electrode of the first set of the first internal electrodes is adjacent to and parallel with separated from each second internal electrode of the second set of the second internal electrodes, and each first internal electrode of the first set of the first internal electrodes separated from each second internal electrode of the second set of the second internal electrodes by a single dielectric layer.

In an implementation of the multilayer ceramic capacitor of the first additional example embodiment, wherein the interaction between the plate portions of the first and second internal electrodes produces a piezoelectric effect having a corresponding internal strain in the multilayer ceramic capacitor, and wherein the fifth set of first internal electrodes reduces the corresponding internal strain.

According to a second additional example embodiment, a multilayer ceramic capacitor includes:

dielectric body;

first and second conductive terminations, such as external electrodes separated by the dielectric body;

parallel plate first internal electrodes embedded in the dielectric body, a first gap in each first internal electrode forms first plate portions that are electrically isolated from each other;

parallel plate second internal electrodes embedded in the dielectric body, where a second gap in each second internal electrode forms second plate portions that are electrically isolated from each other;

wherein the second gap is offset from the first gap in a first longitudinal direction between the first and second conductive terminations,

wherein a second plate portion of the second plate portions overlaps with the first gap and a first plate portion of the first plate portions overlaps with the second gap;

regions of capacitance between sections of the second plate portions that overlap with sections of the first plate portions;

a first group of internal electrodes including a first set of the first internal electrodes and a second set of the second internal electrodes stacked in a second direction perpendicular to the first direction;

a second group of internal electrodes including a third set of the first internal electrodes and a fourth set of the second internal electrodes stacked in the second direction; and

a set of parallel plate third internal electrodes embedded in the dielectric body, where at least one third gap in each third internal electrode forms third plate portions that are electrically isolated from each other,

at least two third internal electrodes adjacent to each other and forming regions of negligible capacitance,

the set of third internal electrodes located between the first and second groups of internal electrodes.

In an implementation of the multilayer ceramic capacitor of the second additional example embodiment, wherein the first gap comprises a plurality of first gaps in the first internal electrodes and the second gap comprises a plurality of second gaps in the second internal electrodes.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as "first," "second," and the like may be used solely to distinguish one entity or action from another entity or action without necessarily requiring or implying any actual such relationship or order between such entities or actions. The phrase "at least one of," "at least one selected from the group of," or "at least one selected from" followed by a list is defined to mean one, some, or all, but not necessarily all of, the elements in the list. The terms "comprises," "comprising," "including," or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by "a," "an," or the like does not, without more constraints, preclude the existence of additional identical elements in the process, method, article, or apparatus that comprises the element. Also, the term "another" is defined as at least a second or more. The terms "including," "having," and the like, as used herein, are defined as "comprising." Terms of approximation, such as “approximately,” “near,” “substantially,” and/or other related terms, unless otherwise defined, are defined as a range within +/- 5% of the approximated element, a range within +/- 10% of the approximated element, and/or a range close enough to the approximated element to achieve an intended result. All elements of the disclosed embodiments can be modified with such terms. Furthermore, the background section is not admitted as prior art, is written as the inventor's own understanding of the context of some embodiments at the time of filing, and includes the inventor's own recognition of any problems with existing technologies and/or problems experienced in the inventor's own work.

What is claimed is:

1. A multilayer ceramic capacitor comprising:
a dielectric body;
first and second conductive terminations separated by the dielectric body;
a plurality of parallel plate internal electrodes forming a stack of electrode layers embedded in the dielectric body;
first and second groups of internal electrodes of the plurality of parallel plate internal electrodes, each group including a first internal electrode and a separate nearby second internal electrode, where a first gap of the first internal electrode is offset relative to a second gap of the separate nearby second internal electrode in a first direction between the first and second conductive terminations,
wherein a section of the first internal electrode overlaps with a section of the second internal electrode to form regions of capacitance in each group of internal electrodes; and
a set of at least two third internal electrodes of the plurality of parallel plate internal electrodes located between the first and second groups of internal electrodes,
wherein the at least two third internal electrodes are stacked adjacent to each other and form a region of negligible capacitance.

2. The multilayer ceramic capacitor of claim 1,
wherein the first internal electrodes have a different voltage potential than the second internal electrodes, and
wherein the third internal electrodes have a same voltage potential as each other.

3. The multilayer ceramic capacitor of claim 2, wherein the third internal electrodes have the same voltage potential as the first internal electrodes.

4. The multilayer ceramic capacitor of claim 1,
wherein the third internal electrodes in the set of at least two third internal electrodes each comprise a gap that overlaps with a gap of the other third internal electrode in the first direction to form overlapping plate sections with the regions of negligible capacitance therebetween.

5. The multilayer ceramic capacitor of claim 4,
wherein the gap of the third internal electrodes overlaps with the gap of the first internal electrode.

6. The multilayer ceramic capacitor of claim 1,
wherein interaction between the first and second internal electrodes stacked in adjacent layers produces a piezoelectric effect having a corresponding internal strain in the multilayer ceramic capacitor, and
wherein stacked third internal electrodes reduce the corresponding internal strain.

7. The multilayer ceramic capacitor of claim 1, wherein the plurality of parallel plate internal electrodes form a stack of internal electrodes in a second direction perpendicular to the first direction.

8. The multilayer ceramic capacitor of claim 1, wherein each internal electrode of the plurality of parallel plate internal electrodes is separated from each other by a dielectric layer.

9. The multilayer ceramic capacitor of claim 1, wherein at least one of the parallel plate internal electrodes includes plate portions that are electrically isolated from each other by at least one gap in the first direction.

10. The multilayer ceramic capacitor of claim 1,
wherein the first and second groups of internal electrodes comprise a plurality of first groups of internal electrodes and a plurality of second groups of internal electrodes, and
wherein the set of at least two third internal electrodes comprise a plurality of sets of at least two third internal electrodes, each set of at least two third internal electrodes located between each respective first group of internal electrodes and each respective second group of internal electrodes.

11. The multilayer ceramic capacitor of claim 1, wherein each group comprises a plurality of first internal electrodes stacked with a plurality of second internal electrodes in a second direction perpendicular to the first direction, where at least one first internal electrode alternates with at least one second internal electrode in the second direction.

12. The multilayer ceramic capacitor of claim 1, further comprising a plurality of groups of internal electrodes including: the first group of internal electrodes, the second group of internal electrodes, and at least one more group of internal electrodes.

13. The multilayer ceramic capacitor of claim 12, wherein the at least one more group of internal electrodes includes at least one fourth internal electrode and a separate nearby at least one fifth internal electrode stacked with the fourth internal electrode in a second direction perpendicular to the first direction.

14. A multilayer ceramic capacitor comprising:
a dielectric body;
first and second conductive terminations separated by the dielectric body;
a plurality of parallel plate internal electrodes forming a stack of electrode layers embedded in the dielectric body, each of the parallel plate internal electrodes including plate portions that are electrically isolated from each other by at least one gap;
first and second groups of internal electrodes of the plurality of parallel plate internal electrodes, where a first gap in a first internal electrode is offset relative to a second gap in a separate nearby second internal electrode in each group,
wherein sections of the plate portions of the first internal electrode overlap with sections of the plate portions of the second internal electrode to form regions of capacitance in each group of internal electrodes; and
a set of at least two third internal electrodes of the plurality of parallel plate internal electrodes, the set of at least two third internal electrodes located between the first and second groups of internal electrodes,
wherein the at least two third internal electrodes are stacked adjacent to each other and form regions of negligible capacitance.

15. The multilayer ceramic capacitor of claim 14,
wherein the first internal electrodes have a different polarity than the second internal electrodes, and
wherein the third internal electrodes have a same polarity as each other.

16. The multilayer ceramic capacitor of claim 15, wherein the third internal electrodes have a same polarity as the first internal electrodes.

17. The multilayer ceramic capacitor of claim 14,
wherein the third internal electrodes in the set of at least two third internal electrodes each comprise a gap that overlaps with a gap of the other third internal electrode to form overlapping plate sections with the regions of negligible capacitance therebetween.

18. The multilayer ceramic capacitor of claim 14,
wherein first internal electrodes alternate with immediately adjacent second internal electrodes of the first and second groups of internal electrodes.

19. The multilayer ceramic capacitor of claim 14,
wherein interaction between the plate portions of first and second internal electrodes stacked in adjacent layers produces a piezoelectric effect having a corresponding internal strain in the multilayer ceramic capacitor, and
wherein stacked third internal electrodes reduce the corresponding internal strain.

20. A multilayer ceramic capacitor, comprising:
a dielectric body;
first and second conductive terminations separated by the dielectric body;
parallel plate first internal electrodes embedded in the dielectric body, where at least one first gap in each first internal electrode forms first plate portions that are electrically isolated from each other;
parallel plate second internal electrodes embedded in the dielectric body, where at least one second gap in each second internal electrode forms second plate portions that are electrically isolated from each other;
the at least one second gap offset from the at least one first gap in a first direction extending between the first and second conductive terminations, the second plate portions overlap with the at least one first gap and first plate portions overlap with the at least one second gap;
a first group of electrodes including a first set of the first internal electrodes and a second set of the second internal electrodes,
each first internal electrode of the first set of the first internal electrodes separated from each second internal electrode of the second set of the second internal electrodes by a dielectric layer;
a second group of electrodes including a third set of the first internal electrodes and a fourth set of the second internal electrodes,
each first internal electrode of the third set of the first internal electrodes separated from each second internal electrode of the fourth set of the second internal electrodes by a dielectric layer; and
a fifth set of the first internal electrodes separated from each other by a dielectric layer,
the fifth set of first internal electrodes located between the first group of electrodes and the second group of electrodes.
